(19) United States
(12) Patent Application Publication
(10) Pub. No.: US 2010/0005014 A1
(43) Pub. Date: Jan. 7, 2010

(54) System and method for providing cost transparency to units of an organization

(75) Inventors: Julie Castle, Raleigh, NC (US); Anne Loh, Flushing, NY (US); Carl Johnson, Cinnaminson, NJ (US); Bijukumar Krishnapillai, Edison, NJ (US); Sharon Scanlon, Hoboken, NJ (US)

Correspondence Address: LEHMAN BROTHERS INC.;C/O MORGAN, LEWIS & BOCKIUS, LLP, 1111 PENNSYLVANIA AVE. N.W., WASHINGTON, DC, 20004, US

(73) Assignee: Barclays Capital Inc., New York, NY (US)

(21) Appl. No.: 12/457,951

(22) Filed: Jun. 25, 2009

Related U.S. Application Data
(60) Provisional application No. 61/075,828, filed on Jun. 26, 2008.

(51) Int. Cl. G06Q 10/00

(52) U.S. Cl. 705/30

(57) ABSTRACT

A system and method provide transparency of costs allocated to a unit of an organization. The method includes steps to receive asset information for an application at a cost transparency engine and identify a direct dependency of the application and an indirect dependency of the application using the asset information for the application. An infrastructure cost for the application is determined based on the direct dependency, the indirect dependency, component consumption by the application, and a unit cost of a service supporting the component. A report is generated, via a reporting tool, presenting the infrastructure cost for the application.

This application claims the benefit of the U.S. Provisional Patent Application No. 61/075,828 filed on Jun. 26, 2008, which is hereby incorporated by reference.

### BACKGROUND OF THE INVENTION

1. Field of the Invention

The present invention relates to a system and method for providing cost transparency to a unit of an organization, and more particularly to a system and method for breaking down shared costs, such as cost of information technology (IT), allocated to a unit.

2. Discussion of the Related Art

There are many costs associated with operating an organization. For example, while dedicated costs for specific items (e.g., products, services, inventory, etc.) for operating the organization are relatively easy to track, costs for non-dedicated items (e.g., shared) are not as simple to track and account for, especially if the organization (e.g., a business) includes multiple units (e.g., business units) that have independent operating budgets and costs. One such cost is the cost associated with the information technology (IT) of the organization.

For example, an organization may have multiple units that require dedicated computer applications for each unit. In a broker/dealer firm, for example, the front office may require a specialized trading application to execute trades for its customers while the back office may require a specialized processing application to clear the executed trades. In this simple example, the costs of developing and maintaining each of the dedicated applications (i.e., the trading application and the processing application) are relatively simple to track and allocate to the appropriate unit (i.e., allocating the cost of the trading application to the front office, and allocating the cost of the processing application to the back office). However, there are other costs associated with each application that need to be allocated to each unit that are not readily transparent.

For example, the trading application used in the front office uses storage space, data bandwidth, and servers on the internal network that are shared with the processing application used in the back office. These shared IT infrastructure and resources, such as network hardware (e.g., servers, storage devices, routers, etc.) and services (e.g., database management, communication support, etc.) also incur costs that need to be allocated to the units. Accordingly, there is a need for an efficient and accurate way to track, assess, and report the allocation of these shared resources to each unit of an organization.

### SUMMARY OF THE INVENTION

Accordingly, the present invention is directed to a system and method for providing transparency of costs allocated to a unit of an organization that substantially obviates one or more problems due to limitations and disadvantages of the related art.

An embodiment of the present invention provides a method and system for determining and breaking down shared infrastructure costs for applications

Another embodiment of the present invention provides a method and system for allocating shared infrastructure costs for applications to a unit of an organization.

Yet another embodiment of the present invention provides a reporting tool for generating reports presenting shared infrastructure costs for applications and the allocation of those shared infrastructure costs for applications to a unit of an organization.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1, 3-6, and 13-17 are exemplary interfaces of the reporting tool of the present invention;

FIG. 2 is a diagram illustrating an example of a cost allocation model;

FIGS. 7-8 illustrate examples of application dependencies;

FIGS. 9A-9C are exemplary interfaces of the reporting tool of the present invention;

FIGS. 10-11 are exemplary process flows in accordance with the present invention;

FIG. 12 is an exemplary illustration of data sets in accordance with the present invention; and

FIG. 18 is a system diagram of an exemplary embodiment of the present invention.

### DETAILED DESCRIPTION OF THE EMBODIMENTS

Reference will now be made in detail to the embodiments of the present invention, examples of which are illustrated in the accompanying drawings.

The system and method in accordance with the present application provides a transparent cost reporting tool for collecting and presenting costs incurred by an organization and allocated to a unit within the organization. For example, information technology (IT) costs allocated to a unit of an organization may not be transparent to the unit because of the nature of IT within the organization. IT costs of an organization can be grouped into two general categories: (1) dedicated costs, and (2) shared infrastructure costs.

Dedicated costs are costs associated with specific-use applications, such as applications for executing trades, trade clearing applications, market data applications, etc. The dedicated costs generally include the developmental cost of building the application and the maintenance cost for keeping the application running smoothly, providing small enhancements as required by the organization, etc. Dedicated costs are generally easy to track and attribute to the unit that uses the dedicated applications.

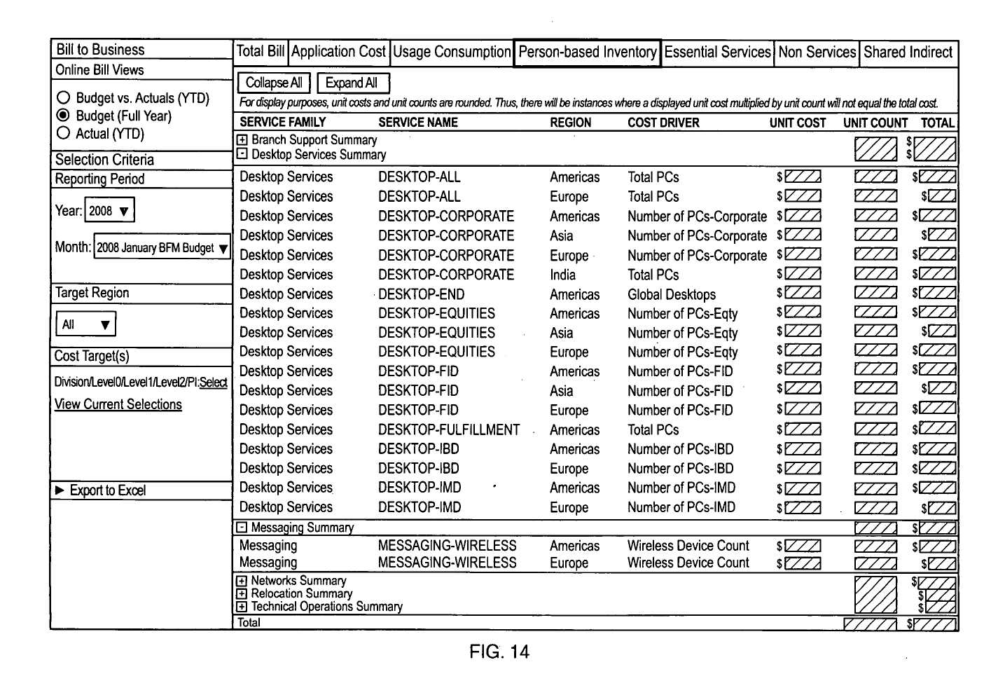

Shared infrastructure costs may be delineated into two sub-categories: (1) those which are attributable to people via consumption of a service (e.g., email storage consumption, number of calls to a help desk, etc.) or ownership of an inventory device requiring support services (e.g., a desktop computer, a wireless device, an IP phone, etc.) and (2) those which are attributable to applications. Person-based shared infrastructure costs are allocated back to the unit based on the amount of service consumed by members of the unit or the number of inventory units associated with that unit. The system and method according to the present invention allows each unit to view these person-based shared infrastructure costs by category and drill down into the actual inventory or usage detail by pulling the detailed information in from disparate inventory and usage tracking systems (see FIG. 14).

Application-related costs are those associated with resources that are shared across units, such as network hardware (e.g., servers, data storage devices, routers, etc.) and services (e.g., communication services, database management, etc.). Applications running on an organization's network will consume various amounts of the shared infrastructure. These costs must be assessed and allocated to the appropriate unit for proper accounting as each unit of an organization typically has its own operating budget. To properly account for the total IT cost of a unit, the total cost needs to include the dedicated cost plus the portion of the shared infrastructure cost attributable to the unit.

The system and method of the present invention analyzes the amount of shared infrastructure consumed by a dedicated application attributable to a unit. The portion of the shared infrastructure used by a dedicated application determines its infrastructure cost. This amount is combined with the dedicated cost of the application to determine the total IT cost for the application.

Every application has one or more infrastructure-related dependencies. Dependencies include the servers, databases, and storage required to host applications in addition to the networks over which applications are delivered, etc. Dependencies are generally categorized as: (1) direct dependencies, and (2) indirect dependencies. Direct dependencies are infrastructure components that are directly related to the application (e.g., host of the application). Indirect dependencies are infrastructure components that are related to an infrastructure component related to the application (e.g., routers used by the host of the application). To properly determine the application consumption of the shared infrastructure, all dependencies (i.e., both direct and indirect) must be identified for the application.

The system and method of the present invention include an asset database (“ADb”) that contains information of every asset (i.e., hardware, software, personnel, building, etc.) in the organization. ADb is primarily a relational database that houses properties for each asset (e.g., Server A having IP address of 10.68.0.0) and maintains relationships between assets (e.g., Server A hosts Application B, managed by Person C, belongs to Department D, etc.). As an example, when an application is created, the application may be recorded into ADb with appropriate relationships and properties that specify all assets consumed by the application. The attributes of the application may include information such as the owner, custodian, server on which the application is loaded, network services needed for the application, storage device on which the data for the application is stored, etc. Similarly, a newly installed server, for example, is recorded in the ADb with information of the owner, custodian, make, model, configuration data, network ID, etc. Details of the ADb are explained in U.S. application Ser. No. 11/025,871 filed Dec. 29, 2004, which is incorporated herein by reference. Accordingly, in accordance with the system and method of the present invention, every application and its dependencies may be ascertained from the ADb to determine the application's consumption of shared infrastructure.

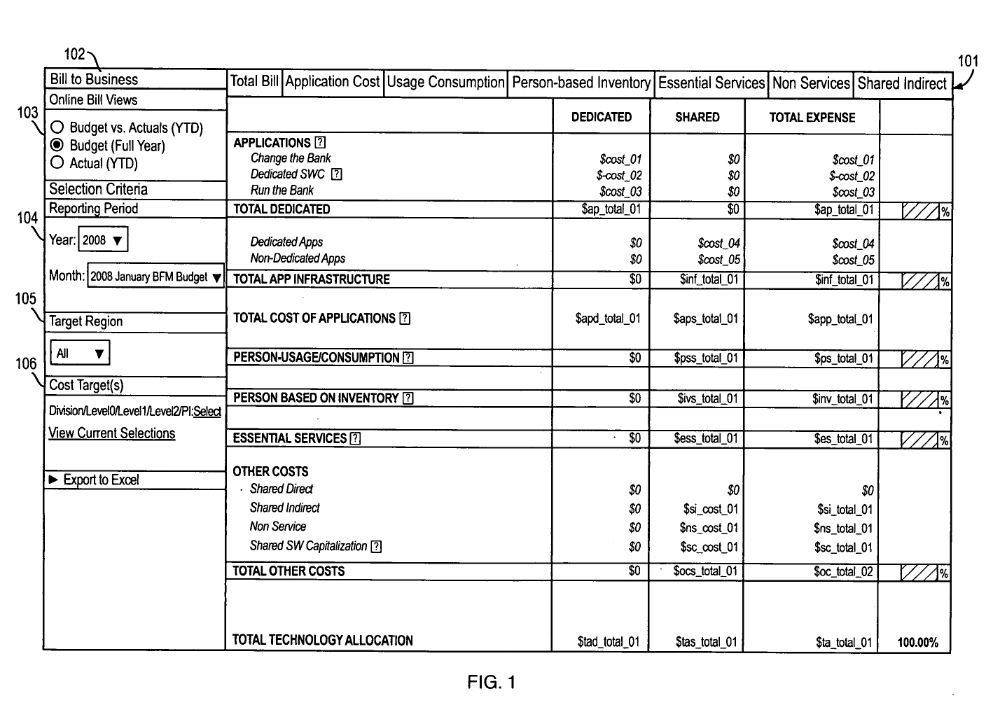

The system and method of the present invention—in addition to the other cost categories mentioned above—includes a reporting tool that presents the unit with application costs including an itemized cost breakdown of each application into dedicated and shared infrastructure cost buckets. The reporting tool of the present invention allows the user to drill down into the shared infrastructure cost in particular. FIGS. 1, 3-6, and 13-17 are exemplary interfaces of the reporting tool of the present invention, which will be described in further detail below. The interfaces of the reporting tool may be a web browser or any other graphical user interface known to those skilled in the art

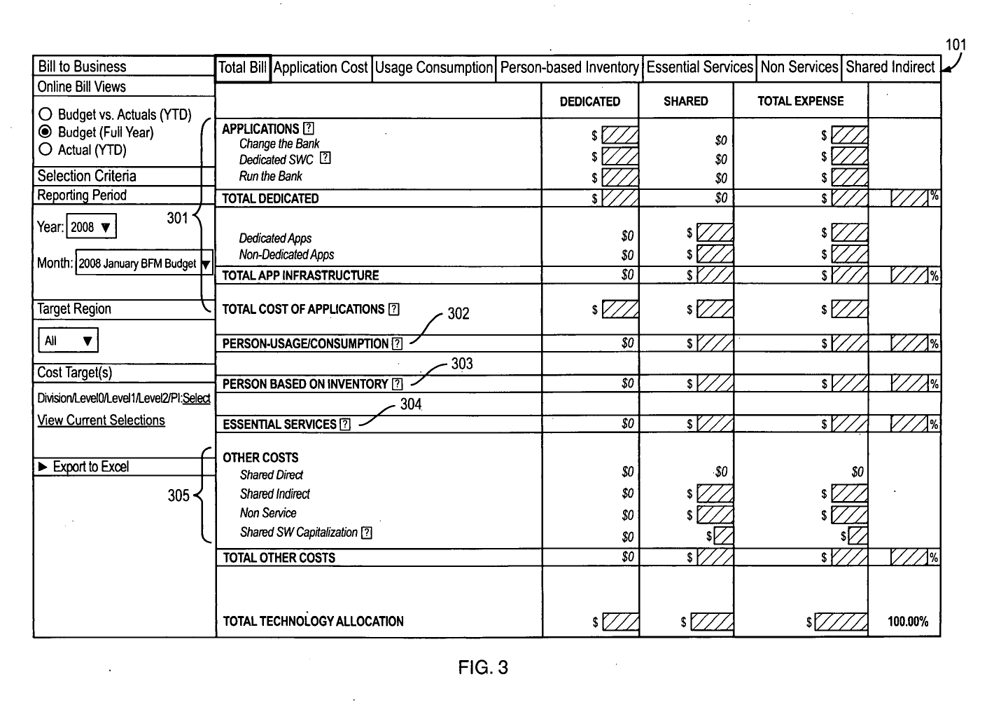

FIG. 1 is an exemplary interface for accessing and navigating the reporting tool. The interface contains a menu tool bar 101 for navigating the reporting tool. The menu tool bar 101 allows a user to access other exemplary interfaces shown in FIGS. 3-6 and 13-17 and described in further detail below and allows a user to view details for a given category of costs (e.g., Application Costs, Usage Consumption, Person-based costs, etc.). The navigation pane 102 allows a user to select selection criteria for use in generating reports of costs by the reporting tool. For example, the interface in FIG. 1 may display various views 103 (e.g., budget (full year) view, actual (year to date “YTD”) view, budget versus actuals (YTD)) based on a selection by a user. The selection criteria of FIG. 1 may further include a reporting period 104, target region 105, and cost targets 106. The target region 105 may be selected by a user through the interface in FIG. 1, and the reporting tool may display cost allocation information by region. The cost targets 106 may be selected by a user to display particular organizational units or businesses (e.g., Divisions, Level 0s, Level 1s, Level 2s, and/or PLs) the user wants to view.

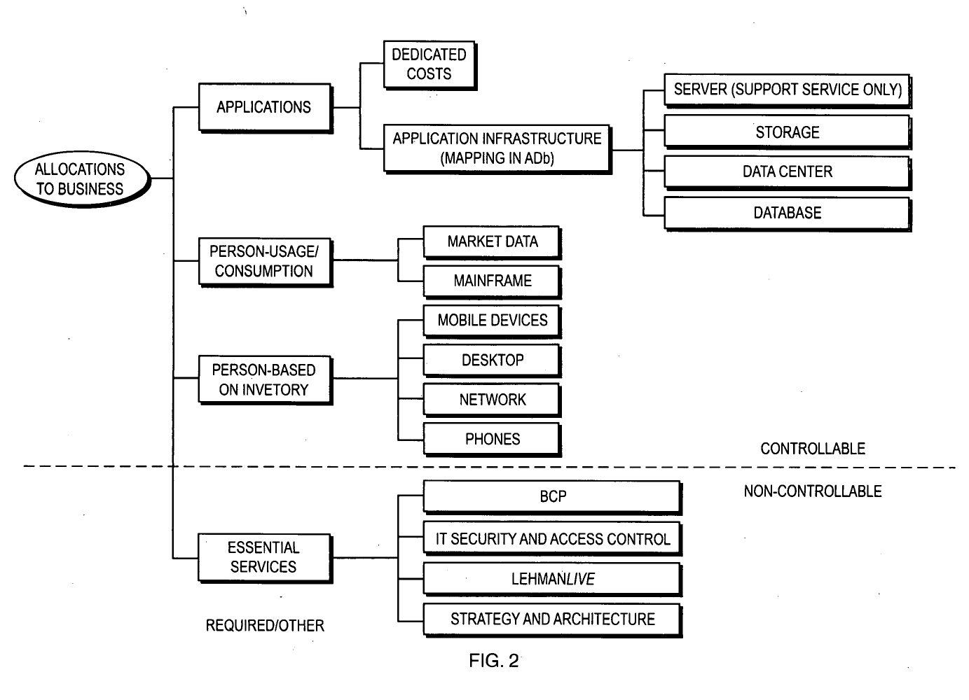

The diagram in FIG. 2 depicts an example of a cost allocation model in which there are four types of drivers:
1) Applications: ties IT costs back to applications;
2) Person-Usage/Consumption: ties IT costs to a person's usage or consumption of services (e.g. e-mail, market data services);
3) Person-Based on Inventory: ties IT costs to physical assets used in conducting business (e.g., mobile devices, desktop PCs); and
4) Essential Services: distributes IT costs among headcount.

FIG. 3 is an exemplary interface displaying costs associated with the drivers, namely applications 301, person-usage/consumption 302, person-based on inventory 303, essential services 304, and in addition, other costs 305. The exemplary interface may be accessed by clicking on the category “Total Bill” of the menu tool bar 101. The other costs 305 may include shared direct costs, shared indirect costs, non-service costs, and shared software capitalization costs. Shared direct costs may include costs to the business from information technology (IT) administration or technical support. Shared indirect costs may includes costs allocated back to the front office. Non-service costs may include costs from IT infrastructure groups which are project-related (vs. service-related). Shared software capitalization costs may also include amortization for various software or infrastructure applications.

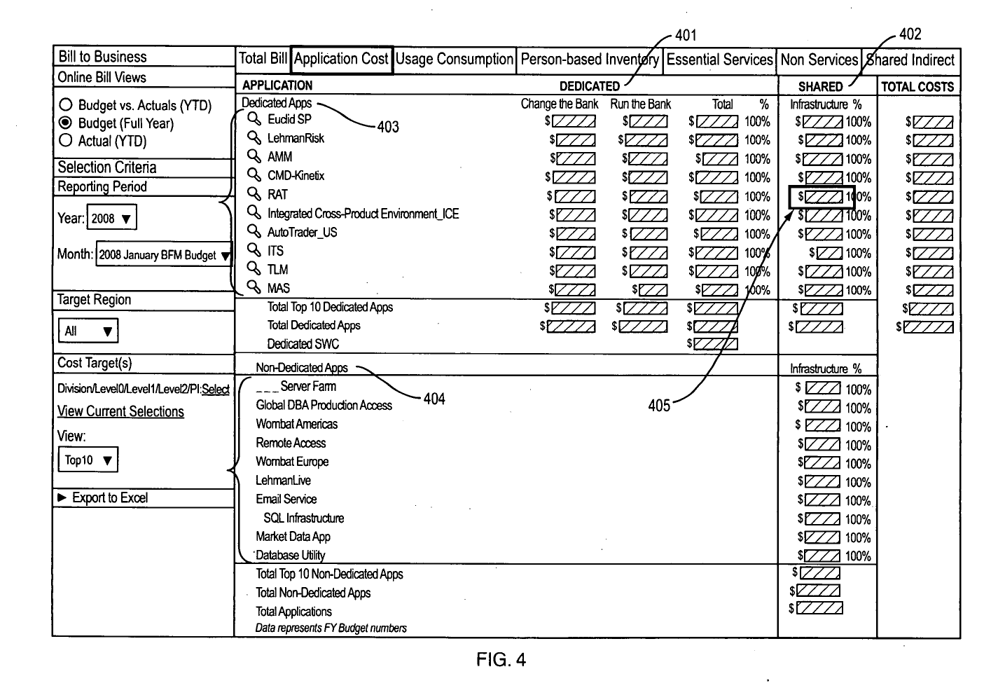

Application costs are split into two sub-categories as shown in FIG. 4: Dedicated 401 and Shared Infrastructure 402. The Dedicated costs 401 associated with an application are the Development cost−the cost of building the application−plus the Maintenance cost−the cost of keeping the application running smoothly, adding functional enhancements, etc. Development and Maintenance costs are charged back to units based on sponsorship assignment in a project management tool (e.g., Business Engine Network—BEN) for the development and maintenance of the projects/budgets. Activities associated with the application costs may be broken out into various categories (e.g., Change the Bank, Dedicated SWC, Run the Bank). Change the Bank/Organization may be development efforts that extend or deliver a new capacity to an application, platform, or services, or an existing application, platform, or services that gives an organization a competitive edge and build the bank/organization for revenue growth, with new technological levels and offerings. Run the Bank/Organization refers to maintenance activities that are required to operate the firm or organization to maintain stability and undisrupted business transactions. Run the Bank/Organization may be described as activities relating to maintaining the technology and not building or developing any new capacity. Dedicated SWC or software capitalization may refer to development efforts performed by a technology team that is dedicated to a specific business, and that development cost is capitalizable over a number of years, usually, the useful life of the development project. This results in a credit or a lower technology cost in a given year since the cost is spread over a number of years.

The second Applications sub-category—Shared Infrastructure costs 402—encompasses certain IT infrastructure service costs that are associated with and charged back to the application. For example, the engineering of the databases which the application references, the support of the server infrastructure on which the application depends, the servers, databases, and storage required to host applications, the networks over which applications are delivered, etc. These are shared costs, as all applications bear a share of the cost of these services. By default, Shared Infrastructure costs 402 for a given application may be charged out to units (e.g., P&Ls) based on the same Maintenance sponsorship assignments, although CAOs (Chief Administrative Officers) may manually override these allocation percentages on a case-by-case basis.

The above explanation pertains to how Dedicated application costs 403 are computed—Dedicated applications are unit-specific applications. There is a second category of applications called Non-Dedicated 404. These are infrastructure-centric applications—they are not used by the front office but rather are used by the IT side in support of front office business activities. Non-Dedicated applications 404 consume their share of Shared Infrastructure services and bear the costs associated therein; the costs borne by these applications are allocated back to the units based on headcount.

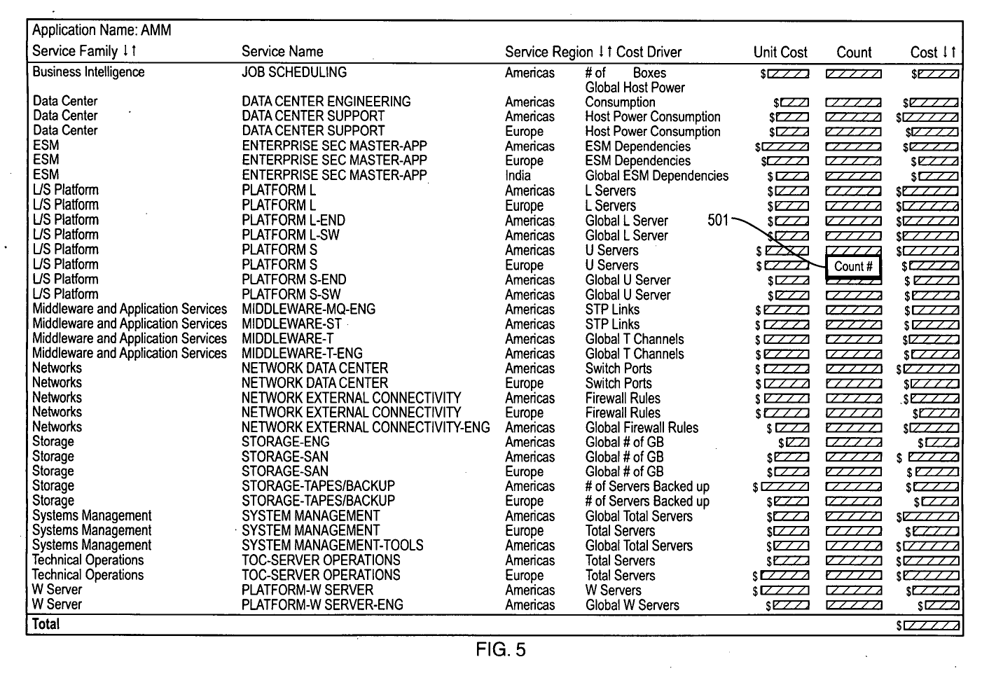

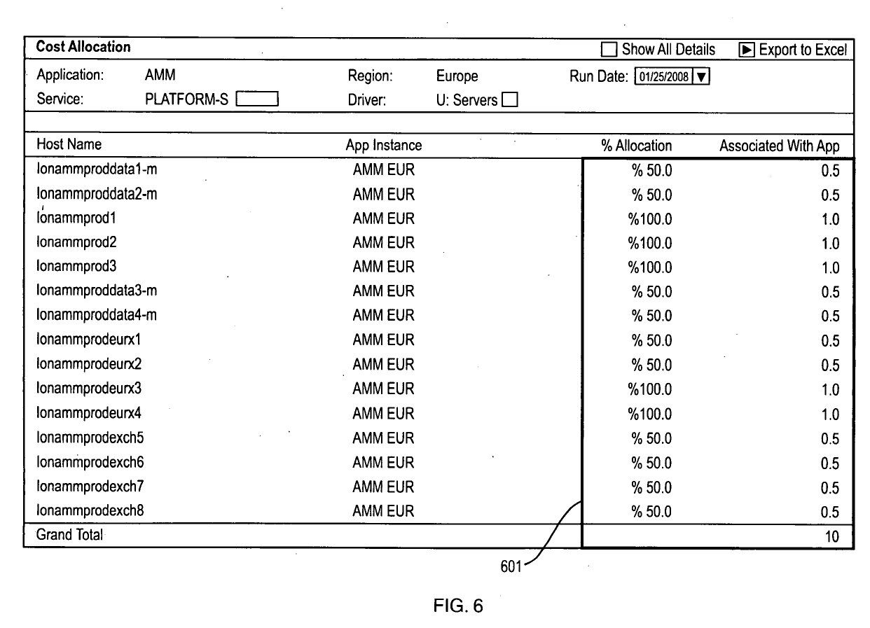

By selecting a shared infrastructure cost item, such as the cost item 405 in FIG. 4, the reporting tool of the present invention, as shown in the exemplary interface of FIG. 5, displays a list of shared infrastructure services consumed by the application, including: (1) the driver for each service, which defines how service costs are allocated (i.e., “Cost Driver”), (2) the unit cost (i.e., “Unit Cost”), (3) the number of infrastructure components associated with the application (i.e., “Count”), and (4) the total cost per service. Other consumption information may be displayed without departing from the scope of the present invention (e.g., the host region of the service). By selecting the unit count of an infrastructure component 501, the reporting tool of the present invention, as shown in the exemplary interface of FIG. 6, drills down further into ADb-level data to show the actual dependencies used as the basis for unit count derivation 601.

Deriving Shared Infrastructure Costs for Applications

The underlying logic of the cost allocation model is that the Shared Infrastructure cost of an application is based on the consumption of components on which the application depends—its dependencies. The consumption of each dependency component is multiplied by unit cost of the service(s) in support of that component, and these values are summed. Thus:

application shared services cost=({component 1} consumption×{service 1} unit cost)+({component 2} consumption×{service 2} unit cost)+({component n} consumption×{service n} unit cost)

Component consumption is derived from a combination of direct and indirect dependencies. Direct component consumption is computed by identifying the application's direct dependencies and the costs associated therein. Indirect (or inherited) consumption is incurred by the application's dependencies' dependencies. Consumption is one step (or more) removed from the application, but can be allocated back to the application.

Unit costs are calculated on a regional basis where possible by dividing the total budget for a service—e.g. operating system Support—by the number of units.

Determining Application Consumption

Direct Dependencies

An application has direct dependencies on infrastructure components, examples of which are Hosts (Operating Systems), Databases, Storage, Middleware, Task Management Boxes, and Market Data. (See FIG. 2.)

The logic used in calculating the application's consumption of each dependency component is as follows:
1) For a given application, identify all of its instances (Prod, DR, Stage, Dev, etc.);
2) For each of the application's instances, determine all direct dependencies;
3) For each direct dependency, determine what—if any—other unrelated application instances share that dependency's resources; and
4) Calculate the application's percentage (%) consumption of that dependency. resource by dividing its share from the total number of application instances using that resource

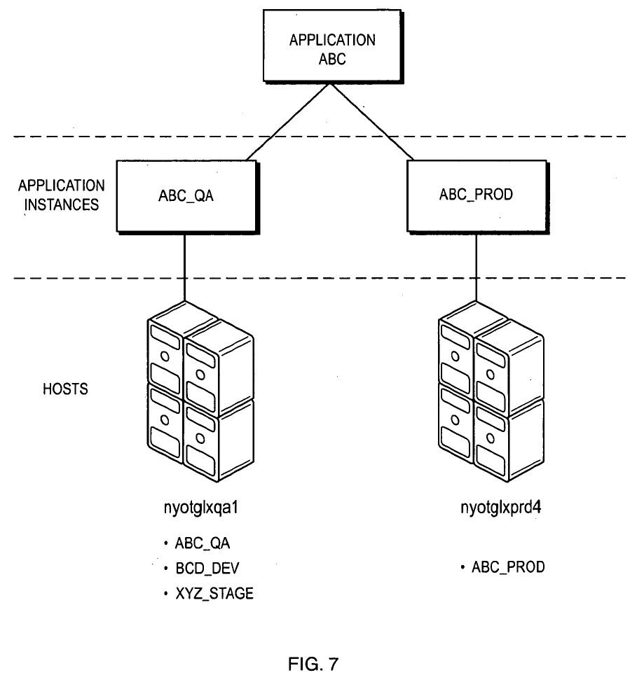

For example, referring to FIG. 7, Application ABC has a QA instance: ABC_QA and a Prod instance: ABC_Prod. ABC_QA has a direct dependency on host “nyotglxqa1.” Host “nyotglxqa1” also hosts application instances belonging to different applications BCD_DEV and XYZ_Stage. ABC_QA's consumption of host “nyotglxqa” is computed as ⅓, or a 0.33 share of the host. ABC_Prod has a direct dependency on host “nyotglxprd4”, and is in fact the only instance residing on that host. Its allocation for that host is 1.00. Adding together the allocations of its instances, Application ABC has a consumption of 1.33 hosts.

Indirect/Inherited Dependencies

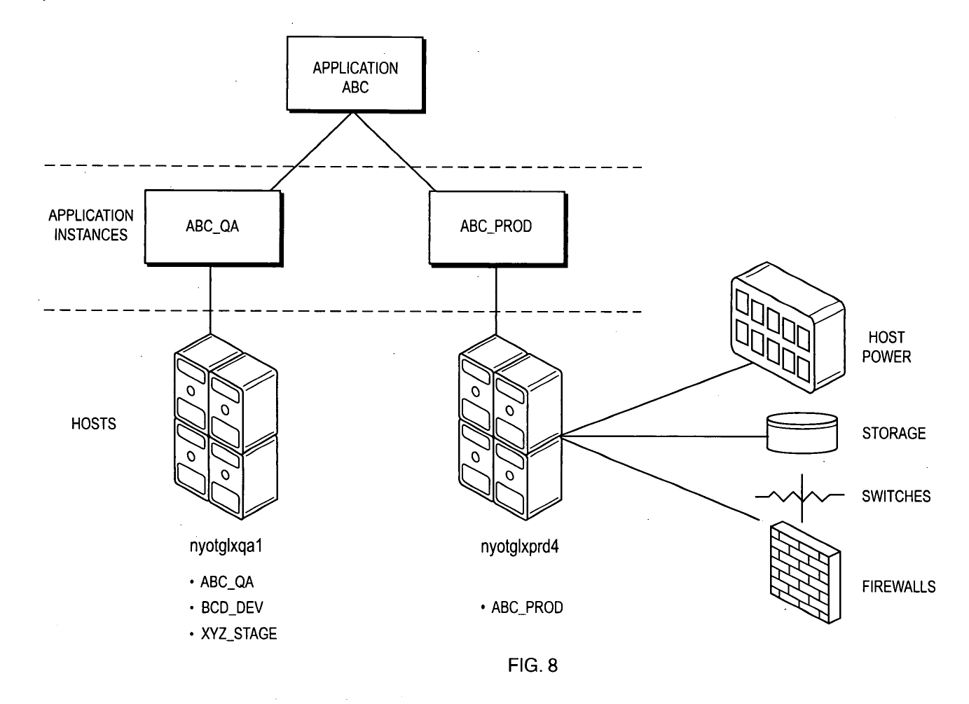

A direct dependency, such as a host in the example above in FIG. 7, has its own set of dependencies. These include Data Center power draw (Host Power Consumption), Storage (Clustered and Non-Clustered), Data Server Storage, Routers and Switches, Firewalls, and Virtualization. Applications, therefore, inherit these host dependencies as shown in FIG. 8.

Determining Service Unit Cost

A service's unit cost is derived by dividing the total budget of a service by the number of supported components:

$$unit cost = \frac{service budget}{\# of components}$$

Another term for “# of components” is “driver unit count.” Put another way:

$$unit cost = \frac{service budget}{driver unit count}$$

Some components have multiple infrastructure services associated with them. In the case of hosts, for example, there is an OS specific support service and there is a separate OS specific engineering service.

Fully-Loaded App Costs

To calculate the fully-loaded cost of an application, add its Dedicated (Dev+Maintenenance) costs to its Shared Infrastructure costs.

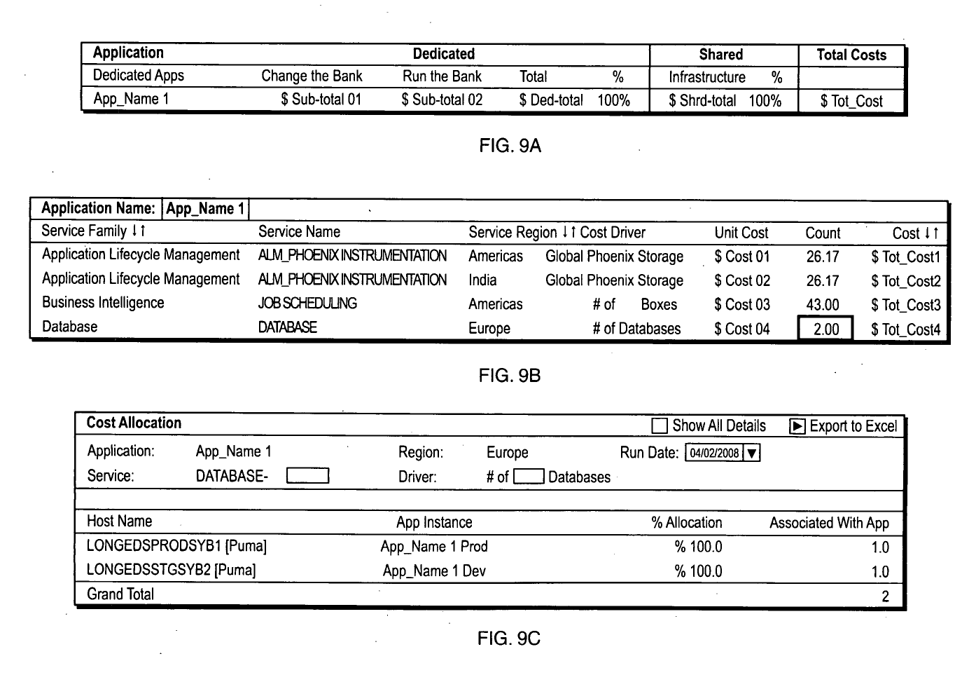

In the reporting tool or IT Cost Transparency application of the present invention, this information is easily viewable as shown in FIG. 9A. The interface of FIG. 4 also shows this information.

The Dedicated costs are broken out into Change the Bank (Dev) and Run the Bank (Maintenance, SEPL) initiatives with a Total Dedicated cost given. The Shared Infrastructure costs are shown in FIGS. 5 and 9B, allowing a user to drill into how that cost is derived.

Clicking a “Service Family,” “Service Name,” or “Cost Driver” in FIGS. 5 and 9B links to view more information. Clicking any “Count” of FIGS. 5 and 9B links to view how those counts are compiled as shown in FIGS. 6 and 9C.

The resulting screen shows which infrastructure pieces have been modeled as dependencies in ADb. In FIG. 6, details screens demonstrate how unit counts are derived. This example shows that the AMM application has dependencies on various S hosts, and what percentage (%) of each host is consumed by AMM. If AMM is the only application residing on that host, it will be assigned a 100% allocation. Likewise, if AMM shares a host with a second application, AMM will incur a 50% (0.5) allocation.

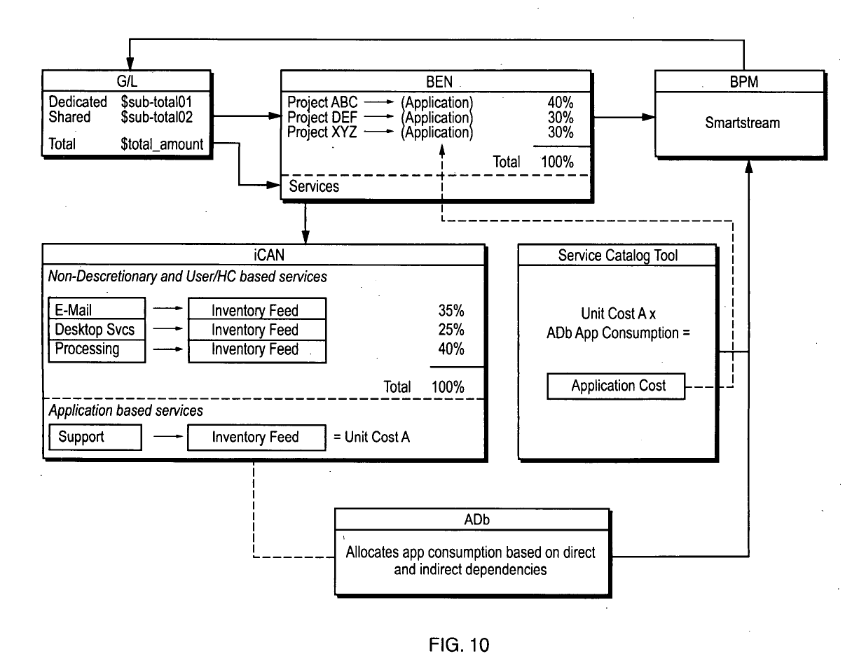

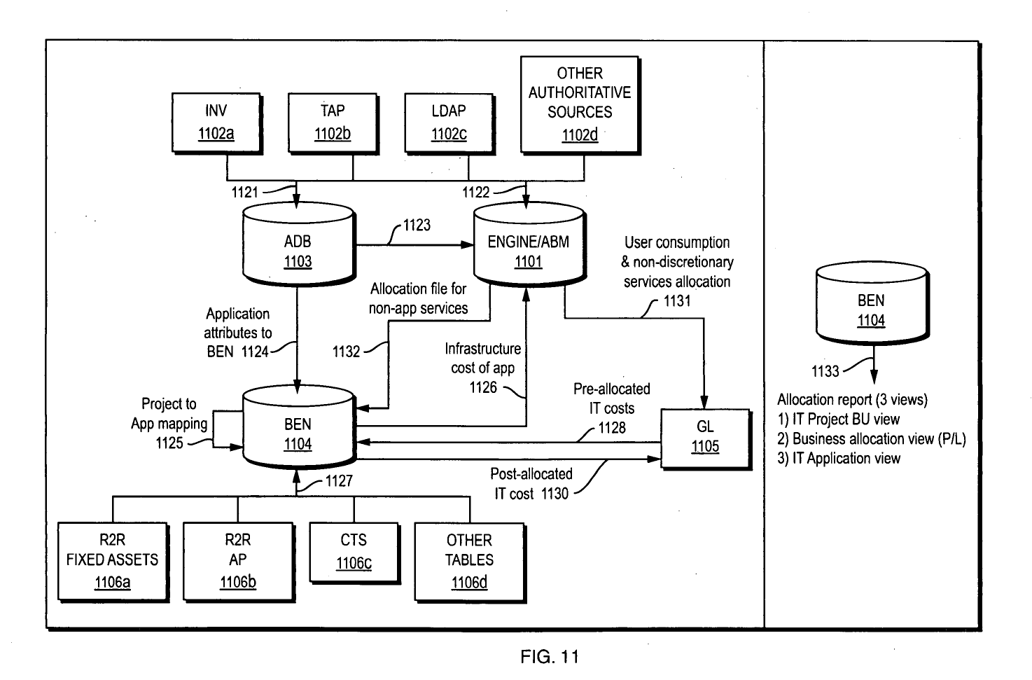

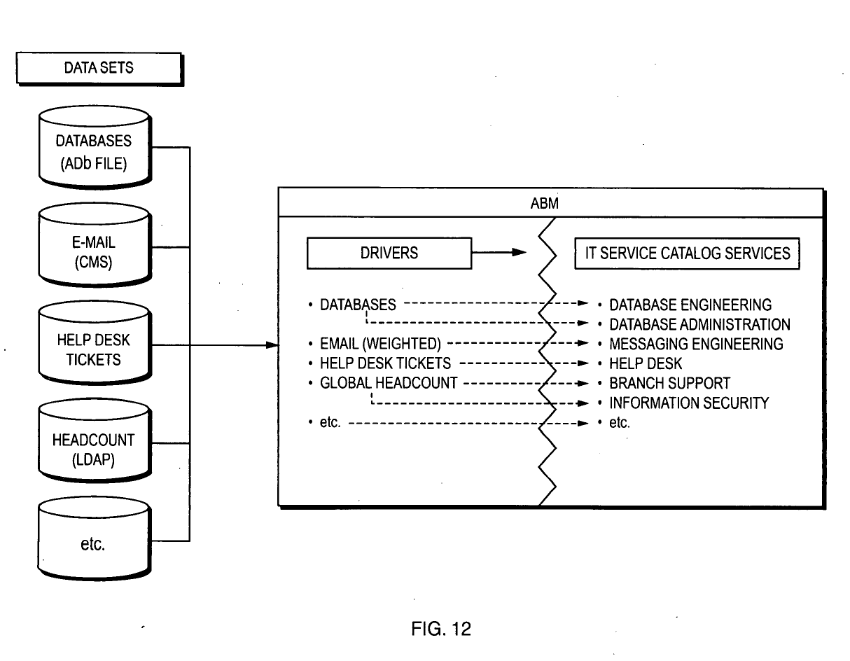

Exemplary process flows for allocating costs and system relationships are illustrated in FIG. 10 and FIG. 11. FIG. 10 illustrates an example of the interdepencies among the different systems that allow the pricing and allocation concept to work by assigning costs in one system, inventory drivers in another system, and embedded logic in the systems to extend the drivers and/or inventory to an asset, be it a person or an application. A cost transparency allocation engine (e.g., Activity Based Management, or ABM) 1101 collects inventory data for each driver from various sources (e.g., INV 1102a, Technology Administrative Portal (TAP) 1102b, LDAP 1102c, ADb 1103, or other authoritative data sources 1102d). These data sets are used as a basis for drivers. In turn, these drivers feed the engine's allocations for all IT services. Pictorially, the data may look as illustrated in FIG. 12.

An example of how the engine 1101 collects inventory data is as follows. The ADb 1103 may receive application information for the discovery of application consumption of direct and indirect dependencies from various sources 1102a-1102d (see 1121). This information (e.g., application consumption of infrastructure services) may be fed to the engine 1101 from the ADb 1103 (see 1123). Further, information related to inventory counts may be fed to the engine 1101 for service allocation (see 1122).

According to the consumption of resources, engine 1101 uses this data as a basis for allocation. This can be best illustrated in the following example:

| SERVICE FAMILY | SERVICE | REGION | GLOBAL? | DRIVER | DRIVER SOURCE |
|---|---|---|---|---|---|
| Desktop Services | DESKTOP - FID | Americas | N | Number of PCs - FID | Desktop TAP (Global) |
| Desktop Services | DESKTOP - FID | Europe | N | Number of PCs - FID | Desktop TAP (Global) |
| Desktop Services | DESKTOP - FID | Asia | N | Number of PCs - FID | Desktop TAP (Global) |

In this example, the TAP 1102b may provide the global inventory of desktops each month. From that, the engine 1101 determines the number of personal computers attributable to a unit. The engine 1101 may further break out the unit's PC data into separate regions, for example.

The ADb 1103 may provide application attributes to a project management tool (e.g., Business Engine Network—BEN) 1104 for cross referencing by project management tool 1104 (see 1124). For example, project management tool 1104 may map projects to applications (see 1125). The engine 1101 may send the infrastructure cost of applications to project management tool 1104 (e.g., ADb count*unit count) (see 1126). The engine 1101 may send the infrastructure cost of applications in the following format: AppName, Region, Service Family (Category), Service, Driver, Count, Unit Cost, Total Cost. Various source systems 1106a-1106d may provide information to project management tool 1104 to perform month end closing processes, which may tie cost to General Ledger (GL) 1105 (see 1127). Further, pre-allocated IT costs may be sent from GL 1105 to project management tool 1104 (see 1128). At 1129, project management tool 1104 may feed engine 1101 with actual cost allocations by services for engine 1101 to compute residual values. After a month end process, project management tool 1104 may send post-allocated IT costs to GL 1105, including dedicated and infrastructure costs for all applications (see 1130). Engine 1101 may send service allocation information for user consumption and non-discretionary services allocation (inventory count*unit cost) to GL 1105 (see 1131). An allocation file may be sent to project management tool 1104 for non-application services to populate allocation reports for shared services (see 1132). Project management tool 1104 may generate allocation reports (e.g., 1) IT project/unit view; 2) Unit allocation view (P/L); and 3) IT application view) (see 1133).

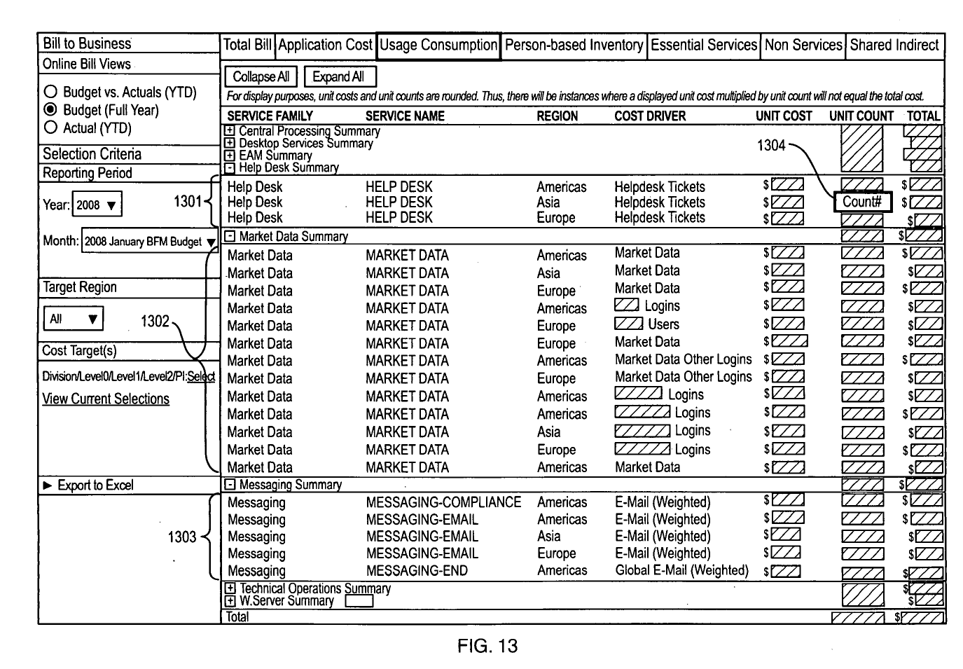

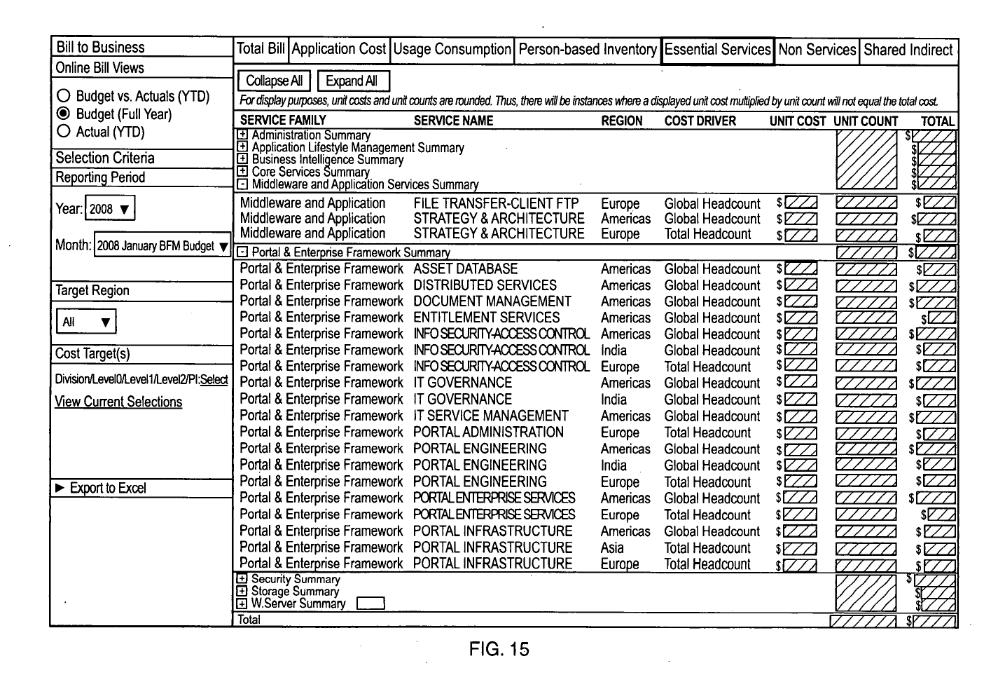

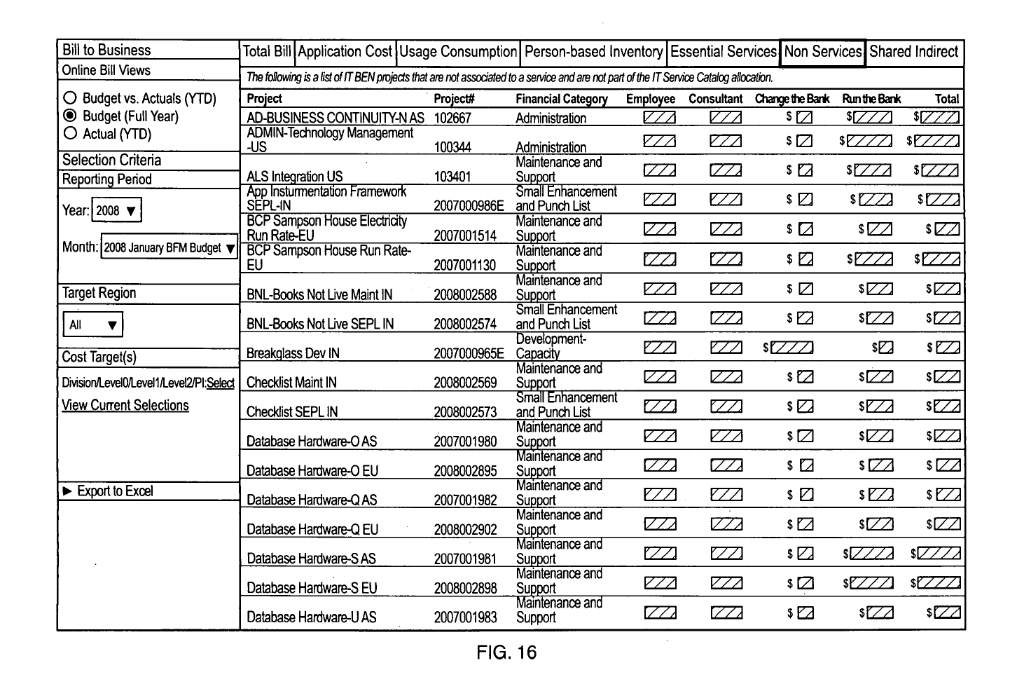

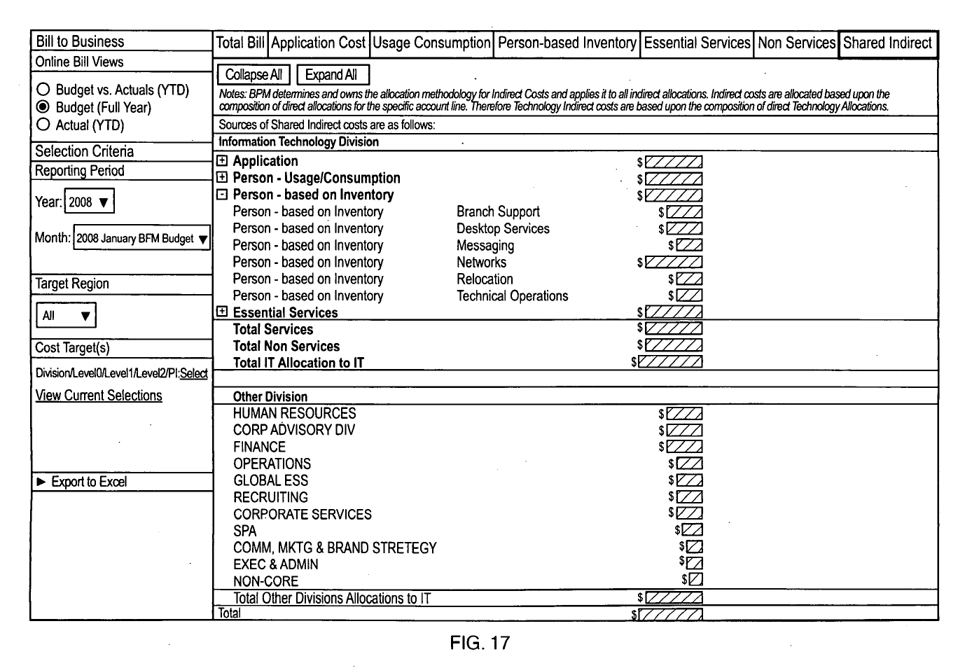

FIGS. 13-17 illustrate additional exemplary interfaces of the reporting tool of the present invention. Each of these interfaces may be accessed by clicking the relevant category in the menu tool bar 101. FIG. 13 illustrates a view showing usage consumption details. For example, at 1301, the consumption costs associated with help desk issue resolution are displayed. At 1302, consumption costs associated with various market data services are displayed. At 1303, consumption costs associated with email usage are displayed. At 1304, if a user clicks on the unit count for any service, the driver inventory is displayed, which will show who is incurring costs for a selected division. FIG. 14 illustrates a view showing person-based inventory costs. FIG. 15 illustrates a view showing essential services costs. FIG. 16 illustrates a view showing non-services costs. FIG. 17 illustrates a view showing shared indirect costs.

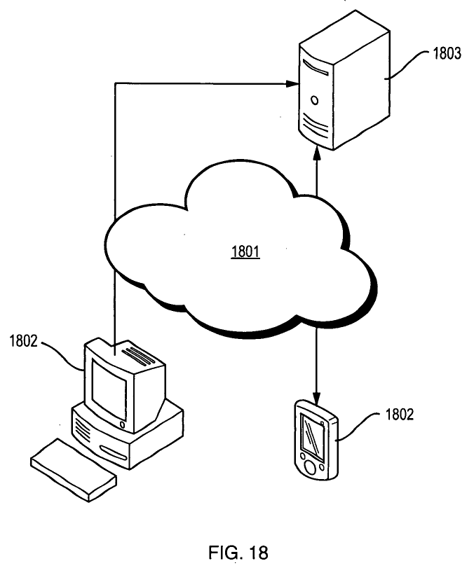

FIG. 18 is a system diagram of an exemplary embodiment of the present invention. The system and method of the present invention may be implemented on one or more client devices 1802 in communication with one or more servers 1803 over a communications network 1801. The communications network 1801 may be a local area network (LAN), wide area network (WAN), point-to-point connection (i.e., direct access), or over a distributed network, such as the Internet. The communications network 1801 may be wired or wireless. The client devices 1802 may be desktop computers, laptop computers, handheld computers, digital personal assistants, and other data communications devices. The one or more servers 1803 may be in communication with the cost transparency allocation engine 1101, various data sources 1102-d, ADb 1103, and the other system components of FIG. 11.

It will be apparent to those skilled in the art that various modifications and variations can be made in the system and method of the present invention without departing from the spirit or scope of the invention.

1. A method, comprising:
receiving asset information for an application at a cost transparency engine;
identifying a dependency of the application using the asset information for the application;
determining an infrastructure cost for the application allocated to an organizational unit based on the dependency, a consumption of a component by the application, and a unit cost; and
generating a report, via a reporting tool, presenting the infrastructure cost for the application allocated to the organizational unit.

2. The method of claim 1 further comprising the steps of:
determining the total cost allocated to the organizational unit for the application based on at least the infrastructure cost of the application and a dedicated cost of the application; and
generating a report, via the reporting tool, presenting a total cost allocated to the organizational unit for the application.

3. The method of claim 1, wherein the consumption of the component by the application is based on the dependency of the application.

4. The method of claim 1, wherein the unit cost is the unit cost of a service supporting the component.

5. The method of claim 4, wherein the unit cost of the service supporting the component is based on a total budget for the service and a component count.

6. The method of claim 1 further comprising the step of analyzing the generated report, via the reporting tool, to present the infrastructure cost for the application, a driver for a service, a component count, and the unit cost.

7. The method of claim 1, wherein the component includes one or more of the following: a server, a database, a data storage device, and a communications network.

8. The method of claim 1, wherein the dependency is a direct dependency of the application.

9. The method of claim 1, wherein the dependency is a direct dependency of the application and an indirect dependency of the application.

10. A system, comprising:
an asset database configured to store asset information for an application;
a cost transparency allocation engine configured to receive asset information for an application, identify a dependency of the application using the asset information for the application allocated to an organizational unit, and determine an infrastructure cost for the application based on the dependency, a consumption of a component by the application, and a unit cost; and
a reporting tool configured to generate a report presenting the infrastructure cost for the application allocated to the organizational unit.

11. The system of claim 10, wherein the cost transparency allocation engine is further configured to determine the total cost allocated to the organizational unit for the application based on at least the infrastructure cost of the application and a dedicated cost of the application; and
the reporting tool is further configured to generate a report presenting a total cost allocated to the organizational unit for the application.

12. The system of claim 10, wherein the consumption of the component by the application is based on the dependency of the application.

13. The system of claim 10, wherein the unit cost is the unit cost of a service supporting the component.

14. The system of claim 13, wherein the unit cost of the service supporting the component is based on a total budget for the service and a component count.

15. The system of claim 10, wherein the reporting tool is further configured to analyze the generated report to present the infrastructure cost for the application, a driver for a service, a component count, and the unit cost.

16. The system of claim 10, wherein the component includes one or more of the following: a server, a database, a data storage device, and a communications network.

17. The system of claim 10, wherein the dependency is a direct dependency of the application.

18. The system of claim 10, wherein the dependency is a direct dependency of the application and an indirect dependency of the application.

19. A computer program product including a computer readable medium having stored thereon computer executable instructions that, when executed by a computer, direct the computer to perform a method comprising the steps of:
receiving asset information for an application;
identifying a dependency of the application using the asset information for the application;
determining an infrastructure cost for the application allocated to an organizational unit based on the dependency, a consumption of a component by the application, and a unit cost; and
generating a report presenting the infrastructure cost for the application allocated to the organizational unit.

20. The computer program product of claim 19 further including computer executable instructions that, when executed by the computer, configure the computer to perform the steps of:
determining the total cost allocated to the organizational unit for the application based on at least the infrastructure cost of the application and a dedicated cost of the application; and
generating a report presenting a total cost allocated to the organizational unit for the application.

21. The computer program product of claim 20, wherein the consumption of the component by the application is based on the dependency of the application.

22. The computer program product of claim 20, wherein the unit cost is the unit cost of a service supporting the component.

23. The computer program product of claim 22, wherein the unit cost of the service supporting the component is based on a total budget for the service and a component count.

24. The computer program product of claim 20 further including computer executable instructions that, when executed by the computer, configure the computer to perform the step of analyzing the generated report to determine the infrastructure cost for the application, a driver for a service, a component count, and the unit cost.

25. The computer product of claim 20, wherein the component includes one or more of the following: a server, a database, a data storage device, and a communications network.

26. The computer product of claim 20, wherein the dependency is a direct dependency of the application.

27. The computer product of claim 20, wherein the dependency is a direct dependency of the application and an indirect dependency of the application.
